(19) United States
(12) Patent Application Publication
(10) Pub. No.: US 2013/0182570 A1
(43) Pub. Date: Jul. 18, 2013

(54) Method and Apparatus for Limiting Bearer Service in Radio Communication

(71) Applicant: HUAWEI TECHNOLOGIES CO., LTD., Shenzhen (CN)

(72) Inventor: Gang Wang, Beijing (CN)

(73) Assignee: HUAWEI TECHNOLOGIES CO., LTD., Shenzhen (CN)

(21) Appl. No.: 13/718,481

(22) Filed: Dec. 18, 2012

(30) Foreign Application Priority Data
Dec. 29, 2011 (CN) 201110452218.7

(51) Int. Cl. H04W 28/02

(52) U.S. Cl. CPC H04W 28/0268
USPC 370/235

(57) ABSTRACT

The present invention discloses a method and an apparatus for limiting a bearer service in radio communication. The method includes: determining that a capability of a terminal system is in a critical condition; in a first bearer set of the terminal system including at least two bearers used for transmitting data, determining a set formed by some bearers in the first bearer set as a second bearer set, where priority of a bearer in the second bearer set is lower than priority of a bearer in the first bearer set excluding those in the second bearer set; and performing service limitation processing on the bearer in the second bearer set.

### CROSS-REFERENCE TO RELATED APPLICATIONS

This application claims priority to Chinese Patent Application No. 201110452218.7, filed on Dec. 29, 2011, which is hereby incorporated by reference in its entirety.

### FIELD OF THE INVENTION

The present invention relates to the field of communications, and in particular, to a method and an apparatus for limiting a bearer service in radio communication in the field of communications.

### BACKGROUND OF THE INVENTION

Quality of service (Quality of Service, QoS for short) becomes an important technical indicator of an internet protocol (Internet Protocol, IP for short) network, where a switching device with a QoS capability is being introduced into a network system, and a QoS support capability is specially considered in the design of an IP header of the internet protocol version 6 (Internet Protocol version 6, IPv6 for short). Technical indicators for measuring the QoS of IP usually include bandwidth/throughput, latency, jitter, and packet loss ratio.

Different users and/or services have different requirements on QoS technical indicators. By effectively implementing various QoS technologies, an operator is capable of effectively controlling network resources and their usage, and integrating multiple services such as voice, data, and video on a single IP network platform, so as to be capable of segmenting customers on an existing network and providing characteristic differential services according to different customer demands.

The third generation partnership project (Third Generation Partnership Project, 3GPP for short) introduces an end-to-end QoS guarantee mechanism, and introduces technologies such as multi-bearer and multi-access point name (Access Point Name, APN for short), so that limited radio resources are used by high-priority services in preference, thereby improving the QoS.

Furthermore, with the introduction of a long term evolution (Long Term Evolution, LTE for short) system, a rate increases dramatically, an end-to-end delay decreases significantly, the QoS is improved, and in addition, the multi-bearer technology is introduced, thereby creating possibilities for various new services. Various services of the LTE system are mapped to different bearers through a traffic flow template (Traffic Flow Template, TFT for short), and corresponding QoS is obtained according to different QoS class identifiers (QoS Class Identifier, QCI for short) and so on of the bearers.

However, limited by consideration on the cost, size, power consumption, and so on, a high-speed LTE handheld terminal system inevitably encounter a system resource bottleneck under a complex service model; therefore it is difficult to guarantee the QoS.

In an existing terminal system, a multi-bearer service model is usually designed according to an empirical value, and configured with a memory to meet requirements of a normal service scenario. When an extreme case where resources of the terminal system are limited occurs, extreme scenario protection is performed. For example, a radio access bearer management (Radio Access Bearer Management, RABM for short) module or a module closer to a front end is notified of performing packet discarding processing, that is, the terminal system suspends a service, and the RABM is notified to restore normal processing after the system restores the capability. However, if the problem roots in a system capability bottleneck caused by a service model, the terminal system is repeatedly in a discontinuous working status due to the same problem even if the RABM has restored the processing.

Therefore, in the existing terminal system, it is difficult for the terminal system to guarantee the QoS of a service, especially the QoS of a high-priority services when resources are limited.

### SUMMARY OF THE INVENTION

Embodiments of the present invention provide a method and an apparatus for limiting a bearer service in radio communication, which are capable of guaranteeing QoS of high-priority services.

In one aspect, an embodiment of the present invention provides a method for limiting a bearer service in radio communication. The method includes: determining that a capability of a terminal system is in a critical condition; in a first bearer set of the terminal system including at least two bearers used for transmitting data, determining a set formed by some bearers in the first bearer set as a second bearer set, where priority of a bearer in the second bearer set is lower than priority of a bearer in the first bearer set excluding those in the second bearer set; and performing service limitation processing on the bearer in the second bearer set.

In another aspect, an embodiment of the present invention provides an apparatus for limiting a bearer service in radio communication. The apparatus includes: a first determining module, configured to determine that a capability of a terminal system is in a critical condition; a second determining module, configured to, in a first bearer set of the terminal system including at least two bearers used for transmitting data, determine a set formed by some bearers in the first bearer set as a second bearer set, where priority of a bearer in the second bearer set is lower than priority of a bearer in the first bearer set excluding those in the second bearer set; and a processing module, configured to perform service limitation processing on the bearer in the second bearer set determined by the second determining module.

Based on the foregoing technical solutions, in the method and apparatus for limiting a bearer service in radio communication according to the embodiments of the present invention, by performing service limitation processing on part of bearers with low priority, system resources are released to be used by a bearer with high priority, so that the terminal system processes a high-priority service when resources are limited, thereby guaranteeing the QoS of the high-priority service and improving the robustness and service experience of the terminal system.

### BRIEF DESCRIPTION OF THE DRAWINGS

To illustrate technical solutions in embodiments of the present invention more clearly, accompanying drawings required for describing the embodiments of the present invention are briefly introduced in the following. Apparently, the accompanying drawings in the following description merely show some embodiments of the present invention, and persons of ordinary skill in the art can derive other drawings from these accompanying drawings without creative efforts.

FIG. 1 is a schematic flow chart of a method for limiting a bearer service in radio communication according to an embodiment of the present invention;

FIG. 2 is another schematic flow chart of a method for limiting a bearer service in radio communication according to an embodiment of the present invention;

FIG. 3 is a schematic block diagram of an apparatus for limiting a bearer service in radio communication according to an embodiment of the present invention; and

FIG. 4 is another schematic block diagram of the apparatus for limiting a bearer service in radio communication according to an embodiment of the present invention.

### DETAILED DESCRIPTION OF THE EMBODIMENTS

Technical solutions in embodiments of the present invention are described clearly and completely in the following with reference to accompanying drawings in the embodiments of the present invention. Apparently, the described embodiments are merely part rather than all of the embodiments of the present invention. All other embodiments obtained by persons of ordinary skill in the art based on the embodiments in the present invention without creative efforts shall fall within the protection scope of the present invention.

It should be understood that the technical solutions in the embodiments of the present invention may be applied in various communication systems, such as a global system of mobile communication (Global System of Mobile communication, GSM for short), a code division multiple access (Code Division Multiple Access, CDMA) system, a wideband code division multiple access (Wideband Code Division Multiple Access, WCDMA for short) system, a general packet radio service (General Packet Radio Service, GPRS for short), a long term evolution (Long Term Evolution, LTE for short) system, an LTE frequency division duplex (Frequency Division Duplex, FDD for short) system, an LTE time division duplex (Time Division Duplex, TDD for short), a universal mobile telecommunication system (Universal Mobile Telecommunication System, UMTS for short), and a worldwide interoperability for microwave access (Worldwide Interoperability for Microwave Access, WiMAX for short) communication system.

It should further be understood that, in the embodiments of the present invention, a terminal system may be referred to as a user equipment (User Equipment, UE for short), a terminal (Terminal), a mobile station (Mobile Station, MS for short), a mobile terminal (Mobile Terminal), or the like. The terminal system may communicate with one or more core networks through a radio access network (Radio Access Network, RAN for short). For example, the terminal system may be a mobile phone (or referred to as a cellular phone) or a computer with a mobile terminal. For example, the terminal system may also be a portable mobile apparatus, pocket-size mobile apparatus, handheld mobile apparatus, a mobile apparatus built in a computer or a vehicular mobile apparatus, where these mobile apparatuses exchange voice and/or data with the radio access network. It is not limited by the present invention, and for example, the terminal system may further include a wired access terminal with a multi-bearer characteristic.

FIG. 1 shows a schematic flow chart of a method 100 for limiting a bearer service in radio communication according to an embodiment of the present invention. As shown in FIG. 1, the method 100 includes:

S110: Determine that a capability of a terminal system is in a critical condition.

S120: In a first bearer set of the terminal system including at least two bearers used for transmitting data, determine a set formed by some bearers in the first bearer set as a second bearer set, where priority of a bearer in the second bearer set is lower than priority of a bearer in the first bearer set excluding those in the second bearer set.

S130: Perform service limitation processing on the bearer in the second bearer set.

When the capability of the terminal system is in the critical condition, that is, the capability of the terminal system encounters a bottleneck, an apparatus for limiting a bearer service in radio communication may determine part of bearers with low priority in a set of bearers of the terminal system, where the set of bearers are used for transmitting data; and perform service limitation processing on the part of bearers with low priority. Therefore, when the terminal system reaches a capability limit, service experience on a bearer with a high QoS requirement is guaranteed in preference, and a high-priority service of the terminal system with a complex service model has a strong interference resistance capability, so that the terminal system has desirable robustness in a complex service scenario. Furthermore, a problem in the prior art that when resources of the terminal system are limited, a service on a bearer with high priority is affected by a service on a bearer with low priority at the same time, and meanwhile the QoS degrades, and even worse, a high-priority real-time services is not available is avoided.

Therefore, in the method for limiting a bearer service in radio communication according to the embodiment of the present invention, by performing service limitation processing on the part of bearers with low priority, system resources are released to be used by the bearer with high priority, so that the terminal system is capable of processing the high-priority service when the resources are limited, thereby guaranteeing the QoS of the high-priority service and improving the robustness and service experience of the terminal system.

It should be understood that if the capability of the terminal system is in the critical condition, the terminal system repeatedly performs service limitation processing on the part of bearers with low priority until the terminal system exits the critical condition and finally restores a normal operating status.

In S110, the apparatus for limiting a bearer service in radio communication determines that the capability of the terminal system is in the critical condition. The apparatus for limiting a bearer service in radio communication may determine, according to that a resource usage amount of the terminal system reaches a threshold, that the capability of the terminal system is in the critical condition or reaches an upper limit, and may also determine, according to factors such as a temperature of a module or a service processing sequence of the terminal system, that the capability of the terminal system is in the critical condition. Optionally, the apparatus for limiting a bearer service in radio communication determines that the capability of the terminal system is in the critical condition, according to at least one factor among a memory usage amount of the terminal system, a central processing unit (Central Processing Unit, CPU for short) remaining amount, and the temperature of the module of the terminal system.

Specifically, the apparatus for limiting a bearer service in radio communication may determine that the capability of the terminal system is in the critical condition, when at least one of the following cases occurs: the memory usage amount of the terminal system is greater than a first memory threshold, the central processing unit CPU remaining amount of the terminal system is smaller than a first CPU threshold, and the temperature of the module of the terminal system is higher than a first temperature threshold.

For example, when a memory monitoring module of the terminal system finds that the memory usage amount is greater than 80%, it may be determined that the capability of the terminal system is in the critical condition; when a CPU monitoring module of the terminal system finds that the CPU remaining amount of the terminal system is smaller than 10% or a CPU usage amount is greater than 90%, it may be determined that the capability of the terminal system is in the critical condition; when a temperature control monitoring module of the terminal system finds that the temperature of the module of the terminal system is higher than 100° C., it may be determined that the capability of the terminal system is in the critical condition. Definitely, when the terminal system meets two or more of the foregoing conditions, it may also be determined that the capability of the terminal system is in the critical condition.

It should be understood that the first memory threshold being 80%, the first CPU threshold being 10%, and the first temperature threshold being 100° C. are merely taken as an example for illustration, and do not limit the present invention. A value of each threshold may differ according to different actual application scenarios or requirements. It should further be understood that the module includes, for example, a subscriber identity module (Subscriber Identity Module, SIM for short), a battery, and various chips.

In S120, the apparatus for limiting a bearer service in radio communication determines the set formed by some bearers in the first bearer set as the second bearer set.

In the embodiment of the present invention, a bearer (Bearer) includes various bearers used to transmit data in an LTE system or other communication systems, for example, a radio bearer (Radio Bearer) between a user equipment (UE) and a base station (eNB), an S1 bearer (S1 Bearer) between a base station and a serving gateway (Serving GateWay, SGW for short), an S5/S8 bearer (S5/S8 Bearer) between a serving gateway (SGW) and a packet data network gateway (Packet Data Network Gateway, PGW for short), an external bearer (External Bearer) between a PGW and a peer entity (Peer Entity), and an evolved packet system (Evolved Packet System, EPS for short) bearer (EPS Bearer) between a UE and a PGW in end-to-end bearer architecture of the LTE system.

It should be understood that, in the embodiment of the present invention, priority of each bearer may be determined through a negotiation process in the beginning of communication. Usually, according to a QoS requirement of a service, a bearer may be established and priority of the bearer may be determined. However, the priority of the bearer is not decided by the service only, and other factors such as system resources, QoS of subscriber subscription may also need to be considered.

It should further be understood that, in the embodiment of the present invention, the bearer may also refer to a channel that includes one or more bearers, for example, a network card, and a module capable of independently controlling an input source of data. A module such as a network card may be granted different priority according to a corresponding bearer. Specifically, the priority may be priority of a default bearer, or highest priority of a bearer included in the network card, which does not limit the embodiment of the present invention.

Optionally, in the embodiment of the present invention, the apparatus for limiting bearer a service in radio communication determines the set formed by some bearers in the first bearer set as the second bearer set, where a ratio of a sum of service transmission rates of bearers in the second bearer set to a sum of service transmission rates of the bearers in the first bearer set is greater than or equal to a flow control step, and a ratio of a sum of service transmission rates of bearers in the second bearer set excluding a bearer with highest priority to the sum of the service transmission rates of the bearers in the first bearer set is smaller than the flow control step.

For example, the apparatus for limiting a bearer service in radio communication may select a bearer with lowest priority one after another as an element of the second bearer set in ascending order of priority of bearers in the first bearer set, until a ratio of a sum of service transmission rates of selected bearers with low priority to the sum of service transmission rates of the bearers in the first bearer set is greater than or equal to 20%. It should be understood that the flow control step being 20% is merely taken as an example for illustration in the embodiment of the present invention, but does not limit the prevent invention, for example, a value of the flow control step may also be 10%, 30%, or the like.

Optionally, in the embodiment of the present invention, when the memory usage amount is greater than a second memory threshold and the second memory threshold is greater than the first memory threshold, or when the CPU remaining amount is smaller than a second CPU threshold and the second CPU threshold is smaller than the first CPU threshold, or when the temperature of the module is higher than a second temperature threshold and the second temperature threshold is greater than the first temperature threshold, the apparatus for limiting a bearer service in radio communication determines that a set formed by bearers in the first bearer set excluding a bearer for transmitting a guaranteed bit rate (Guaranteed Bit Rate, GBR for short) service is the second bearer set.

It should be understood that the GBR service refer to a high-priority service reserved in a communication system, where the communication system not only includes the LTE system, but also includes various communication systems to which the embodiment of the present invention is applicable.

For example, when the memory usage amount of the terminal system is greater than 90%, or when the CPU remaining amount is smaller than 5%, or when the temperature of the module of the terminal system is higher than 110° C., a set of bearers in the first bear set excluding a bearer for transmitting a reserved high-priority service is determined as the second bearer set.

It should be understood that the second memory threshold being 90%, the second CPU threshold being 5%, and the second temperature threshold being 110° C. are merely taken as an example for illustration, and do not limit the present invention. A value of each threshold may differ according to different actual application scenarios or requirements.

In S130, the apparatus for limiting a bearer service in radio communication performs service limitation processing on the bearer in the second bearer set. The apparatus for limiting a bearer service in radio communication may perform service limitation processing on the bearer in the second bearer set in a manner of packet discarding or flow control.

Optionally, the apparatus for limiting a bearer service in radio communication performs packet discarding processing or flow control processing on the bearer in the second bearer set. Definitely, the apparatus for limiting a bearer service in radio communication may also perform packet discarding processing or flow control processing on part or all of bearers in the second bearer set at the same time. Optionally, the apparatus for limiting a bearer service in radio communication performs service limitation processing on the bearer in the second bearer set one after another in ascending order of priority of bearers.

It should be understood that, when a bearer requiring service limitation does not transmit data normally, to perform service limitation on the bearer is to perform packet discarding processing; when the bearer requiring service limitation is transmitting data normally, to perform service limitation on the bearer is to perform flow control processing, that is, to reduce traffic in data transmission of the bearer. It should further be understood that, when packet discarding processing or flow control processing is performed on all bearers, all service bearers are closed, and for a terminal, a service is suspended.

For example, the apparatus for limiting a bearer service in radio communication selects, starting from a bearer with the lowest priority, a bearer in the first bearer set, and locally disables the bearer. In this way, when TFT mapping is performed on part of services, a service packet with low priority is discarded because no proper bearer is found, thereby decreasing memory consumption and CPU consumption, and lowering the temperature of the module, so that the terminal system may gradually restore a normal status.

For a case where the resources of the terminal system are limited, in the embodiment of the prevent invention, priority of bearers is differentiated, a service on a bearer with low priority is limited first, then a service on a bearer with secondary low priority is limited until a normal status of the system resources is restored. Then the service of the bearer with low priority is gradually restored, and through dynamic adjustment, the system is enabled to work in a safe status with a maximum load. In this way, only an unimportant and non-real-time service with low priority is affected in an extreme service model, while the QoS of other important services can still be guaranteed and the service experience is improved. Meanwhile, because the terminal system works in the safe status with the maximum load, the terminal system is capable of providing a most effective user service in a current service model, and in a case that the robustness of the terminal system is guaranteed, a service requirement of a user is met with a maximum capability of the terminal system.

It should be understood that, in the embodiments of the present invention, the serial numbers of the foregoing processes do not imply an execution sequence, and the execution sequence of the processes should be determined according to their functions and internal logic, so the serial numbers do not serve as any limitation on the implementation of the embodiments of the present invention. For example, as soon as a bearer which is in the second bearer set and meets a condition is determined, the apparatus for limiting a bearer service in radio communication can perform service limitation processing on the bearer, and does not need to perform the service limitation processing on the bearer after all bearers meeting the condition are determined. That is, in the embodiment of the present invention, the process of determining the second bearer set and the process of service limitation processing may be performed at the same time.

Therefore, in the method for limiting a bearer service in radio communication according to the embodiment of the present invention, by performing service limitation processing on the part of bearers with low priority, the system resources are released to be used by the bearer with high priority, so that the terminal system is still capable of processing the high-priority service when the resources are limited, thereby guaranteeing the QoS of the high-priority service and improving the robustness and service experience of the terminal system.

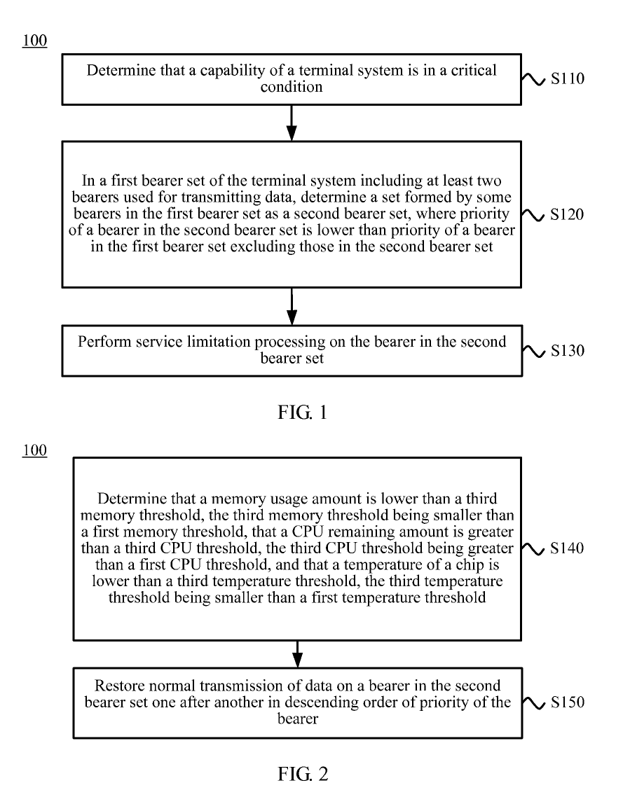

In the embodiment of the present invention, when the capability of the terminal system is restored, a status of a bearer with high priority among bearers disabled locally may be restored, so that the terminal system gradually returns to the normal operating status. At this time, as shown in FIG. 2, the method 100 may further include:

S140: Determine that the memory usage amount is smaller than a third memory threshold, the third memory threshold being smaller than the first memory threshold, that the CPU remaining amount is greater than a third CPU threshold, the third CPU threshold being greater than the first CPU threshold, and that the temperature of the chip is lower than a third temperature threshold, the third temperature threshold being smaller than the first temperature threshold.

S150: Restore normal transmission of data on the bearer in the second bearer set one after another in descending order of priority of bearers.

For example, when determining that the memory usage amount is smaller than 75%, the CPU remaining amount is greater than 20%, and the temperature of the module of the terminal system is lower than 90° C., the apparatus for limiting a bearer service in radio communication may restore the normal transmission of the data on the bearer in the second bearer set one after another in descending order of priority of bearers. Definitely, the apparatus for limiting a bearer service in radio communication may also restore the status of the bearer with high priority in batches for normal data transmission.

It should be understood that the third memory threshold being 75%, the third CPU threshold being 20%, and the third temperature threshold being 90° C. are merely taken as an example for illustration, and do not limit the present invention. A value of each threshold may differ according to different actual application scenarios or requirements.

Therefore, in the method for limiting a bearer service in radio communication according to the embodiment of the present invention, by performing service limitation processing on the part of bearers with low priority, the system resources are released to be used by the bearer with high priority, so that the terminal system is capable of processing the high-priority service when the resources are limited, thereby guaranteeing the QoS of the high-priority service and improving the robustness and service experience of the terminal system.

The present invention is described in detail below with reference to a specific example.

For example, an LTE terminal system adopts a static memory allocation manner, a memory block related to a user plane service is selected as a memory detection object, and a monitoring period is 5 ms. When a memory usage amount exceeds 80%, an RABM module performs selection starting from an active bearer with lowest priority, and locally disables a selected active bearer, until a rate of services disabled this time reaches 20% of a total rate. In this way, when TFT mapping is performed on part of services, a service packet with low priority is discarded because no proper bearer is found, so as to decrease memory consumption; when the memory usage amount exceeds 90%, bearers of all other services, except a GBR service and reserved high-priority service, are set to a locally disabled status.

Similarly, when a CPU remaining amount is smaller than 10% or a temperature of a temperature control monitoring module exceeds 100° C., the RABM module performs selection starting from an active bearer with lowest priority, and locally disables a selected active bearer, until a rate of services disabled this time reaches 20% of a total rate. In this way, when TFT mapping is performed on part of services, a service packet with low priority is discarded because no proper bearer is found, so as to decrease memory consumption; when the CPU remaining amount is smaller than 5% or the temperature of the temperature control monitoring module exceeds 110° C., bearers of all other services, except a GBR service and a reserved high-priority service, are set to a locally disabled status.

When the memory usage amount is smaller than 75%, the CPU remaining amount is greater than 20%, and the temperature of the temperature control monitoring module is lower than 90° C., the apparatus for limiting a bearer service in radio communication selects a bearer with high priority among bearers disabled locally and restores a status of the bearer with high priority. When no bearer in the terminal system is in the locally disabled status, the terminal system returns to a normal operating status.

In an LTE system, real-time game and video services may be organized into a private network, and a service network is accessed through different PGWs. In this way, in the LTE terminal system, different service networks are accessed through a virtual network card, and corresponding service processes are initiated. In this scenario, service flows of the terminal may be differentiated before being mapped to bearers of the LTE system.

Therefore, when the system capability is close to a limit and service limitation is required, flow limitation may be performed based on the QoS of a default bearer of a public data network (Public Data Network, PDN for short) associated to a network card. A process of flow limitation is the same as that described in the foregoing embodiment, but a process of selecting a bearer changes into a process of selecting a network card, and flow control is performed on the selected network card. When it is selected to perform flow control on the network card, no packet is discarded directly, which has less influence on a service and is capable of avoiding service fluctuation caused by retransmission, and is also capable of decreasing occupied system resources more thoroughly. Therefore, when resources of the terminal system are limited and the service limitation is required, flow limitation may be performed on the network card first, and then a bearer is selected to perform flow limitation on.

Therefore, the method for limiting a bearer service in radio communication put forward in the embodiment of the prevent invention improves an end-to-end QoS capability through a combination of QoS solutions of a transmission network and a network device, and when the capability of the terminal system reaches the upper limit, the method is capable of effectively guaranteeing the QoS of a high-priority service and improving the robustness and service experience of the terminal system.

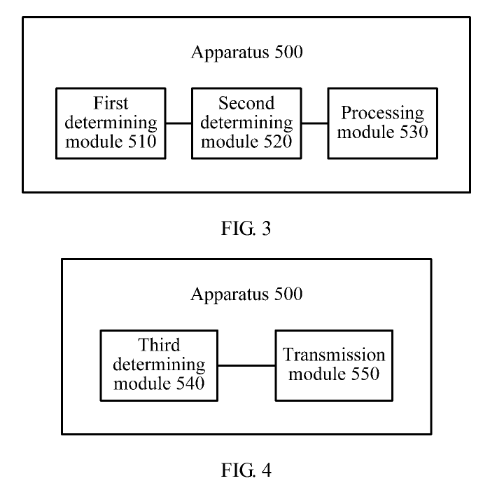

The method for limiting a bearer service in radio communication according to the embodiment of the present invention is described in detail above with reference to FIG. 1 and FIG. 2. An apparatus for limiting a bearer service in radio communication is described below with reference to FIG. 3 and FIG. 4.

FIG. 3 shows a schematic block diagram of an apparatus 500 for limiting a bearer service in radio communication according to an embodiment of the present invention. As shown in FIG. 3, the apparatus 500 includes:

a first determining module 510, configured to determine that a terminal system is in a critical condition;

a second determining module 520, configured to, in a first bearer set of the terminal system including at least two bearers used for transmitting data, determine a set formed by some bearers in the first bearer set as a second bearer set, where priority of a bearer in the second bearer set is lower than priority of a bearer in the first bearer set excluding those in the second bearer set; and

a processing module 530, configured to perform service limitation processing on the bearer in the second bearer set determined by the second determining module 520.

Therefore, in the apparatus for limiting a bearer service in radio communication according to the embodiment of the present invention, by performing service limitation processing on part of bearers with low priority, system resources are released to be used by a bearer with high priority, so that the terminal system is capable of processing a high-priority service when the resources are limited, thereby guaranteeing the QoS of the high-priority service and improving the robustness and service experience of the terminal system.

In the embodiment of the present invention, optionally, the first determining module 510 is further configured to determine that the capability of the terminal system is in the critical condition, when at least one of the following cases occurs: a memory usage amount of the terminal system is greater than a first memory threshold, a central processing unit CPU remaining amount of the terminal system is smaller than a first CPU threshold, and a temperature of a module of the terminal system is higher than a first temperature threshold.

In the embodiment of the present invention, optionally, the second determining module 520 is further configured to determine the set formed by some bearers in the first bearer set as the second bearer set, where a ratio of a sum of service transmission rates of bearers in the second bearer set to a sum of service transmission rates of the bearers in the first bearer set is greater than or equal to a rate threshold, and a ratio of a sum of service transmission rates of bearers in the second bearer set excluding a bearer with highest priority to the sum of the service transmission rates of the bearers in the first bearer set is smaller than the rate threshold.

In the embodiment of the present invention, optionally, the second determining module 520 is further configured to determine that a set formed by bearers in the first bearer set excluding a bearer for transmitting a guaranteed bit rate GBR service is the second bearer set, when the memory usage amount is greater than a second memory threshold and the second memory threshold is greater than the first memory threshold, or when the CPU remaining amount is smaller than a second CPU threshold and the second CPU threshold is smaller than the first CPU threshold, or when the temperature of the module is higher than a second temperature threshold and the second temperature threshold is greater than the first temperature threshold.

In the embodiment of the present invention, optionally, the processing module 530 is further configured to perform packet discarding processing or flow control processing on the bearer in the second bearer set.

In the embodiment of the present invention, optionally, as shown in FIG. 4, the apparatus 500 further includes:

a third determining module 540, configured to determine that the memory usage amount is smaller than a third memory threshold, the third memory threshold being smaller than the first memory threshold, that the CPU remaining amount is greater than a third CPU threshold, the third CPU threshold being greater than the first CPU threshold, and that the temperature of the chip is lower than a third temperature threshold, the third temperature threshold being smaller than the first temperature threshold; and

a transmission module 550, configured to restore normal transmission of data on the bearer in the second bearer set one after another in descending order of priority of bearers.

The apparatus 500 for limiting a bearer service in radio communication according to the embodiment of the present invention may correspond to the apparatus for limiting a bearer service in radio communication according to the embodiment of the present invention, and the foregoing and other operations and/or functions of the modules in the apparatus 500 are used to implement corresponding procedures in the methods shown in FIG. 1 and FIG. 2. To be simplified, details are not described herein.

Therefore, in the apparatus for limiting a bearer service in radio communication according to the embodiment of the present invention, by performing service limitation processing on part of bearers with low priority, the system resources are released to be used by the bearer with high priority, so that the terminal system is capable of processing the high-priority service when the resources are limited, thereby guaranteeing the QoS of the high-priority service and improving the robustness and service experience of the terminal system.

Persons of ordinary skill in the art can be aware that, units and algorithm steps described with reference in each embodiment disclosed in this document can be implemented by electronic hardware, computer software, or a combination of the two. To clearly illustrate the interchangeability between the hardware and the software, the foregoing illustration has generally described composition and steps of each embodiment according to functions. Whether the functions are executed by hardware or software depends on particular applications and design constraint conditions of the technical solutions. Person skilled in the art can use a different method to implement the described functions for each particular application, but it should not be considered that such implementation goes beyond the scope of the present invention.

Persons skilled in the art can understand that, for the purpose of convenient and brief description, for a specific working process of the foregoing system, apparatus and unit, reference may be made to the corresponding process in the method embodiment, and the details will not be described herein again.

In the embodiments provided in the present application, it should be understood that the disclosed system, apparatus, and method may be implemented in other manners. For example, the described apparatus embodiment is merely exemplary. For example, the unit division is merely logical function division and can be other division in actual implementation. For example, multiple units or components can be combined or integrated into another system, or some features can be ignored or not performed. In addition, the displayed or discussed mutual couplings or direct couplings or communication connections may be implemented through some interfaces. The indirect couplings or communication connections between apparatuses or units may be implemented in electronic, mechanical, or other forms.

The units described as separate parts may or may not be physically separate, and parts displayed as units may or may not be physical units, that is, may be located in one position, or may be distributed on multiple network elements. Part or all of the units may be selected according to actual requirements to achieve the objectives of the solutions of the embodiments of the present invention.

In addition, functional units in each embodiments of the present invention may be integrated into a processing unit, or each of the units may exist alone physically, or two or more of the units may be integrated into one unit. The foregoing integrated unit may be implemented in a form of hardware, or may be implemented in a form of a software functional unit.

When being implemented in the form of the software functional unit and sold or used as a separate product, the integrated unit may be stored in a computer-readable storage medium. Based on such understanding, the technical solutions of the present invention essentially, or the part contributing to the prior art, or all or part of the technical solutions may be implemented in a form of software product. The computer software product is stored in a storage medium and includes several instructions for instructing a computer device (which may be a personal computer, a server, or a network device, and the like) to execute all or part of steps of the method described in each of the embodiments of the present invention. The storage medium includes: various media that can store program codes, such as a U-disk, a removable hard disk, a read-only memory (ROM, Read-Only Memory), a random access memory (RAM, Random Access Memory), a magnetic disk, or an optical disk.

What are described above are only exemplary embodiments of the present invention, but do not limit the protection scope of the present invention. Any equivalent modification or substitution that is readily conceivable to those skilled in the art within the technical scope disclosed by the present invention should be covered in the protection scope of the present invention. Therefore, the protection scope of the present invention shall be subject to the appended claims.

What is claimed is:

1. A method for limiting a bearer service in radio communication, comprising:
determining that a capability of a terminal system is in a critical condition;
in a first bearer set of the terminal system comprising at least two bearers used for transmitting data, determining a set formed by some bearers in the first bearer set as a second bearer set, wherein priority of a bearer in the second bearer set is lower than priority of a bearer in the first bearer set excluding those in the second bearer set; and
performing service limitation processing on the bearer in the second bearer set.

2. The method according to claim 1, wherein the determining that the capability of the terminal system is in the critical condition comprises:
determining that the capability of the terminal system is in the critical condition, when at least one of the following cases occurs: a memory usage amount of the terminal system is greater than a first memory threshold, a central processing unit CPU remaining amount of the terminal system is smaller than a first CPU threshold, and a temperature of a module of the terminal system is higher than a first temperature threshold.

3. The method according to claim 2, wherein the determining the set formed by some bearers in the first bearer set as the second bearer set comprises:
determining the set formed by some bearers in the first bearer set as the second bearer set, wherein a ratio of a sum of service transmission rates of bearers in the second bearer set to a sum of service transmission rates of the bearers in the first bearer set is greater than or equal to a flow control step, and a ratio of a sum of service transmission rates of bearers in the second bearer set excluding a bearer with highest priority to the sum of the service transmission rates of the bearers in the first bearer set is smaller than the flow control step.

4. The method according to claim 2, wherein the determining the set formed by some bearers in the first bearer set as the second bearer set comprises:
when the memory usage amount is greater than a second memory threshold and the second memory threshold is greater than the first memory threshold, or when the CPU remaining amount is smaller than a second CPU threshold and the second CPU threshold is smaller than the first CPU threshold, or when the temperature of the module is higher than a second temperature threshold and the second temperature threshold is greater than the first temperature threshold, determining that a set formed by bearers in the first bearer set excluding a bearer for transmitting a guaranteed bit rate GBR service is the second bearer set.

5. The method according to claim 1, wherein the performing service limitation processing on the bearer in the second bearer set comprises:
performing packet discarding processing or flow control processing on the bearer in the second bearer set.

6. The method according to claim 2, further comprising:
determining that the memory usage amount is smaller than a third memory threshold, the third memory threshold being smaller than the first memory threshold, that the CPU remaining amount is greater than a third CPU threshold, the third CPU threshold being greater than the first CPU threshold, and that the temperature of the chip is lower than a third temperature threshold, the third temperature threshold being smaller than the first temperature threshold; and
restoring normal transmission of data on the bearer in the second bearer set one after another in descending order of priority of bearers.

7. An apparatus for limiting a bearer service in radio communication, comprising:
a first determining module, configured to determine that a capability of a terminal system is in a critical condition;
a second determining module, configured to, in a first bearer set of the terminal system comprising at least two bearers used for transmitting data, determine a set formed by some bearers in the first bearer set as a second bearer set, wherein priority of a bearer in the second bearer set is lower than priority of a bearer in the first bearer set excluding those in the second bearer set; and
a processing module, configured to perform service limitation processing on the bearer in the second bearer set determined by the second determining module.

8. The apparatus according to claim 7, wherein the first determining module is further configured to determine that the capability of the terminal system is in the critical condition when at least one of the following cases occurs: a memory usage amount of the terminal system is greater than a first memory threshold, a central processing unit CPU remaining amount of the terminal system is smaller than a first CPU threshold, and a temperature of a module of the terminal system is higher than a first temperature threshold.

9. The apparatus according to claim 8, wherein the second determining module is further configured to determine the set formed by some bearers in the first bearer set as the second bearer set, wherein a ratio of a sum of service transmission rates of bearers in the second bearer set to a sum of service transmission rates of the bearers in the first bearer set is greater than or equal to a flow control step, and a ratio of a sum of service transmission rates of bearers in the second bearer set excluding a bearer with highest priority to the sum of the service transmission rates of the bearers in the first bearer set is smaller than the flow control step.

10. The apparatus according to claim 8, wherein the second determining module is further configured to determine that a set formed by bearers in the first bearer set excluding a bearer for transmitting a guaranteed bit rate GBR service is the second bearer set, when the memory usage amount is greater than a second memory threshold and the second memory threshold is greater than the first memory threshold, or when the CPU remaining amount is smaller than a second CPU threshold and the second CPU threshold is smaller than the first CPU threshold, or when the temperature of the module is higher than a second temperature threshold and the second temperature threshold is greater than the first temperature threshold.

11. The apparatus according to claim 7, wherein the processing module is further configured to perform packet discarding processing or flow control processing on the bearer in the second bearer set.

12. The apparatus according to claim 8, further comprising:
a third determining module, configured to determine that the memory usage amount is smaller than a third memory threshold, the third memory threshold being smaller than the first memory threshold, that the CPU remaining amount is greater than a third CPU threshold, the third CPU threshold being greater than the first CPU threshold, and that the temperature of the chip is lower than a third temperature threshold, the third temperature threshold being smaller than the first temperature threshold; and
a transmission module, configured to restore normal transmission of data on the bearer in the second bearer set one after another in descending order of priority of bearers.
